(19) United States
(12) Patent Application Publication
(10) Pub. No.: US 2005/0144408 A1
(43) Pub. Date: Jun. 30, 2005

(54) Memory protection unit, memory protection method, and computer-readable record medium in which memory protection program is recorded

(76) Inventors: Kenji Ejima, Osaka-shi (JP); Masashige Mizuyama, Neyagawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/020,527

(22) Filed: Dec. 27, 2004

(30) Foreign Application Priority Data
Dec. 24, 2003 (JP) 2003-426800

(51) Int. Cl. G06F 12/14

(52) U.S. Cl. 711/163; 711/156

(57) ABSTRACT

A memory protection unit, a memory protection method and a computer-readable record medium in which a memory protection program is recorded is provided which are capable of preventing a memory from being improperly rewritten by a malfunction in a subroutine. This memory protection unit includes: a memory which has at least one memory area that is used by at least one subroutine, and in which a writing attribute that shows a writing permission or a writing prohibition can be set for every memory area; a subroutine choice section which chooses a subroutine that executes a processing request; a memory-area specification section which specifies a memory area that is used by the subroutine; and a subroutine calling section which sets, to the writing permission, the writing attribute of the specified memory area, calls the chosen subroutine, and sets, to the writing prohibition, the writing attribute of the memory area after completing the execution of the subroutine.

### BACKGROUND OF THE INVENTION

1. Field of the Invention

The present invention relates to memory management in an operating system. Specifically, it relates to a memory protection unit which protects a memory from its improper rewriting. In addition, it also relates to a memory protection method and a computer-readable record medium in which a memory protection program is recorded, which are used to do the same.

2. Description of the Related Art

Conventionally, the following method is known as the art of managing a memory in an operating system, particularly protecting a memory. An application which operates in such a system is divided into several processes. Then, a virtual address space is allocated for each process.

Such a process includes one address space, and is a processing unit which reads and writes in a memory area within the address space. Each process corresponds to a single address space. A thread is a processing unit which shares one address space. Thus, several threads can operate at the same time while reading and writing data within a single address space.

In the method of allocating a virtual address space for each process, one virtual address space is allocated for every process. Each virtual address space operates independently in a memory management unit (or MMU). Hence, a process in operation within the allocated virtual address space cannot obtain access to a memory area in the virtual address space of another process.

The reason is as follows. Even if a malfunction occurs in a process, it cannot affect the virtual address space of another process since the process which has the malfunction is given access only to the virtual address space allocated for itself. Thereby, even though something is wrong with software, it can only affect the area within a process unit. This makes the whole system more stable and durable.

However, in the above described method of allocating a virtual address space for each process, every time the process is switched, it is necessary to change the virtual address space to be used by a memory management unit. Hence, the virtual address space is switched more frequently, thus lengthening an overhead. This may lower the whole system's performance.

Such a deterioration in the performance can largely affect, especially, so-called embedded equipment, such as a cellular phone, a digital television and a household electrical appliance. Thus, in an operating system which presides over the control of embedded equipment, it is difficult to adopt the method of allocating a virtual address space for each process.

Therefore, the following method is often used for the control of embedded equipment. In an entire system, there is only one address space, and all execution units are made not processes, but threads. In this method, all threads share the same address space. Thus, if a malfunction occurs in a thread, it can affect a memory area which is used by another thread.

Hence, an art is disclosed which groups threads that operate in a system, divides an address space into domain Units, and allocates a specific domain for every group (e.g., refer to Japanese Unexamined Patent Publication (kohyo) No. 11-505652 specification). Each thread has access to the memory area of the domain which is allocated for the group it belongs to. However, it has no access to the memory areas of the other domains. Hence, according to this prior art, in a system where several threads operate in a single address space, a malfunction can only affect the area within a domain unit. This makes the system more secure and durable.

However, according to the prior art, in a system which is configured by one or a small number of threads, it is almost impossible to divide a memory into smaller domain units. Particularly, in an operating system which has a monolithic kernel structure such as the Linux (registered trademark), a kernel is configured substantially by one domain. Thus, a memory cannot be divided into a plurality of small domains. According to such a configuration, when a malfunction occurs in a subroutine in a part of a program, that malfunction can affect the whole domain area. The prior are is an art of preventing a part which operates normally in a program from being affected by a part which operates abnormally. However, in an environment where there are only one or a few domains, a malfunction can affect a larger area within a domain. This makes it difficult to prevent a memory from being improperly rewritten.

Accordingly, the above described method of grouping threads and allocating a domain for every group has the following disadvantage. In a system where one or a small number of threads are configured by a large number of subroutines, if a malfunction occurs in a subroutine, it may affect a memory area which is used by another subroutine that operates within one and the same thread.

### DISCLOSURE OF THE INVENTION

In order to resolve the above described conventional disadvantages, it is an object of the present invention to provide a memory protection unit, a memory protection method and a computer-readable record medium in which memory protection program is recorded which are capable of preventing a memory from being improperly rewritten by a malfunction in a subroutine.

A memory protection unit according to the present invention, comprising: a memory which includes at least one memory area that is used by at least one subroutine, and in which a writing attribute is set for every memory area, the writing attribute representing a writing permission or a writing prohibition; a subroutine choosing means for accepting a processing request, and choosing a subroutine which executes the processing request; a memory-area specifying means for specifying a memory area which is used by the subroutine that is chosen by the subroutine choosing means; and a subroutine calling means for setting, to the writing permission, the writing attribute of the memory area which is specified by the memory-area specifying means, thereafter calling and executing the subroutine that is chosen by the subroutine choosing means, and setting, to the writing prohibition, the writing attribute of the memory area which is set to the writing permission after completing the execution of the subroutine.

According to this configuration, before a subroutine is execute, only the writing attribute of the memory area which is used by the subroutine is set to the writing permission. Then, the subroutine is called and executed. After the subroutine has been executed, the writing attribute of the memory area which has been set to the writing permission is set to the writing prohibition. Therefore, only while the subroutine is being executed, permission is given to write in the memory area which corresponds to the subroutine, and writing in the other memory areas is prohibited. This prevents a memory from being improperly rewritten by a malfunction in a subroutine.

Furthermore, in the above described memory protection unit, it is preferable that: in the memory, a subroutine management table be stored which relates the processing request to a subroutine that corresponds to the processing request; and the subroutine choosing means accept a processing request, and choose the subroutine that corresponds to the processing request, by referring to the subroutine management table.

According to this configuration, the subroutine that corresponds to the accepted processing request is chosen by referring to the subroutine management table which relates the processing request to the subroutine that corresponds to the processing request. Therefore, the subroutine that corresponds to the processing request can be easily chosen. This shortens the time which will be taken to choose the subroutine, in other words, it makes such processing faster.

Moreover, in the above described memory protection unit, it is preferable that: in the memory, a memory-area management table be stored which relates the subroutine to a memory area that is used by the subroutine; and the memory-area specifying means specify the memory area which is used by the subroutine that is chosen by the subroutine choosing means, by referring to the memory-area management table.

According to this configuration, the memory area that is used by the chosen subroutine is specified by referring to the memory-area management table which relates the subroutine to the memory area that is used by the subroutine. Therefore, the memory area that is used by the executed subroutine can be easily specified. This shortens the time will be taken to specify the memory area, in other words, it makes such processing faster.

In addition, the above described memory protection unit, preferably, further comprises an interruption response processing means for: when an interruption processing request is issued while a subroutine is executed by the subroutine calling means, setting the writing attribute of the memory area which is used by the subroutine in execution, from the writing permission to the writing prohibition; thereafter calling and executing an interruption response processing which responds to the interruption processing request; and resetting, to the writing permission, the writing attribute of the memory area which is set to the writing prohibition after completing the execution of the interruption response processing.

According to this configuration, when an interruption processing request is issued while a subroutine is executed, the writing attribute of the memory area which is used by the subroutine in execution is set from the writing permission to the writing prohibition. Thereafter, an interruption response processing which responds to the interruption processing request is called and executed. Then, the execution of the interruption response processing is completed. Thereafter, the writing attribute of the memory area which is set to the writing prohibition is reset to the writing permission. Therefore, the contents of the memory area which is used by the subroutine that is in execution before the interruption can be prevented from being rewritten by a malfunction which may occur during the interruption response processing.

Furthermore, the above described memory protection unit may further comprise an interruption response processing means for: when an interruption processing request is issued while a subroutine is executed by the subroutine calling means, calling and executing an interruption response processing which responds to the interruption processing request; in arbitrary timing when the interruption response processing is in execution, setting the writing attribute of the memory area which is used by the subroutine in execution, from the writing permission to the writing prohibition; and resetting, to the writing permission, the writing attribute of the memory area which is set to the writing prohibition after completing the execution of the interruption response processing.

According to this configuration, when an interruption processing request is issued while a subroutine is executed, an interruption response processing which responds to the interruption processing request is called and executed. Then, in arbitrary timing when the interruption response processing is in execution, the writing attribute of the memory area which is used by the subroutine in execution is set from the writing permission to the writing prohibition. Sequentially, the execution of the interruption response processing is completed. Thereafter, the writing attribute of the memory area which is set to the writing prohibition is reset to the writing permission.

Therefore, the writing attribute is not reset shortly after an interruption processing request has been issued. In other words, after the interruption response processing has been executed to some extent, the writing attribute is set in arbitrary timing. This makes it possible to quickly respond to the interruption.

Moreover, in the above described memory protection unit, preferably, the interruption response processing is divided in advance into a top half and a bottom half, and the interruption response processing means: when an interruption processing request is issued while a subroutine is executed by the subroutine calling means, calls and executes the top half of an interruption response processing which responds to the interruption processing request; sets the writing attribute of the memory area which is used by the subroutine in execution, from the writing permission to the writing prohibition after completing the execution of the top half; calls and executes the bottom half of the interruption response processing after setting the writing attribute to the writing prohibition; and resets, to the writing permission, the writing attribute of the memory area which is set to the writing prohibition after completing the execution of the bottom half.

According to this configuration, when an interruption processing request is issued while a subroutine is executed, the top half of an interruption response processing which responds to the interruption processing request is called. Then, after the execution of the top half is completed, the writing attribute of the memory area which is used by the subroutine in execution is set from the writing permission to the writing prohibition. Next, after the writing attribute has been set to the writing prohibition, the bottom half of the interruption response processing is called and executed. Sequentially, after the execution of the bottom half is completed, the writing attribute of the memory area which is set to the writing prohibition is reset to the writing permission.

Therefore, the writing attribute is not reset shortly after an interruption processing request has been issued. In other words, after the top half of the interruption response processing has been executed, the writing attribute is set. Then, after the writing attribute has been set, the bottom half of the interruption response processing is executed. This makes it possible to quickly respond to the interruption. Especially, the top half of the interruption response processing which requires a prompt response can be swiftly executed.

In addition, the above described memory protection unit, preferably, further comprises a memory-protection exception issuing means for issuing a memory-protection exception which is used to execute an exceptional processing when an instruction is issued to write in the memory area where the writing attribute is set to the writing prohibition.

According to this configuration, when an instruction is issued to write in the memory area where the writing attribute is set to the writing prohibition, a memory-protection exception is issued which is used to execute an exceptional processing. Therefore, writing is not executed in the memory area where writing is prohibited. Thus, the contents of memory areas other than the memory area which is used by the subroutine in execution can be prevented from being rewritten. Herein, the exceptional processing is a special processing which is executed in the following case. If a phenomenon takes place where an ordinary processing procedure cannot be continued while a subroutine is in execution, the processing procedure in execution is suspended at that time. Then, the above described special processing is executed according to such a phenomenon.

Furthermore, in the above described memory protection unit, it is preferable that: the memory includes a plurality of modules, each of which has at least one subroutine and at least one memory area which is used by the subroutine; and the memory-protection exception issuing means include an exceptional processing means for executing an exceptional processing which specifies a subroutine in which an instruction is issued to write in the memory area where the writing attribute is set to the writing prohibition, specifies a module which includes the subroutine, and initializes the module.

According to this configuration, when an instruction is issued to write in the memory area where the writing attribute is set to the writing prohibition, a subroutine in which the writing instruction has been issued is specified. Then, a module which includes the specified subroutine is specified. Sequentially, the exceptional processing which initializes the specified module is executed. Hence, if the instruction is issued to write in the memory area where the writing attribute is set to the writing prohibition, initialization is executed in a module unit. This prevents the processing from stopping midway, or from freezing.

Moreover, in the above described memory protection unit, it is preferable that: in the memory, a module management table be stored which relates the subroutine to a module that includes the subroutine; and the exceptional processing means specify the module that includes the subroutine, by referring to the module management table.

According to this configuration, a module that includes the specified subroutine is specified by referring to the module management table which relates the subroutine to the module that includes the subroutine. Therefore, the module that includes the specified subroutine which has accessed the memory area where the writing attribute is set to the writing prohibition can be easily specified. This shortens the time which will be taken to specify the module, in other words, it makes such processing faster.

A memory protection method according to the present invention which is adapted for managing writing in a memory including at least one memory area that is used by at least one subroutine by allowing the memory area to be settable with a writing attribute representing a writing permission or a writing prohibition, comprises: a subroutine choosing step for a subroutine choosing means to accept a processing request, and choose a subroutine which executes the processing request; a memory-area specifying step for a memory-area specifying means to specify a memory area which is used by the subroutine that is chosen in the subroutine choosing step; and a subroutine calling step for a subroutine calling means to set, to the writing permission, the writing attribute of the memory area which is specified in the memory-area specifying step, thereafter call and execute the subroutine that is chosen in the subroutine choosing step, and set, to the writing prohibition, the writing attribute of the memory area which is set to the writing permission after completing the execution of the subroutine.

According to this configuration, before a subroutine is execute, only the writing attribute of the memory area which is used by the subroutine is set to the writing permission. Then, the subroutine is called and executed. After the subroutine has been executed, the writing attribute of the memory area which has been set to the writing permission is set to the writing prohibition. Therefore, only while the subroutine is being executed, permission is given to write in the memory area which corresponds to the subroutine, and writing in the other memory areas is prohibited. This prevents a memory from being improperly rewritten by a malfunction in a subroutine.

A computer-readable record medium is recorded with a memory protection program according to the present invention. The memory protection program is adapted for managing writing in a memory including at least one memory area that is used by at least one subroutine by allowing the memory area to be settable with a writing attribute representing a writing permission or a writing prohibition. The memory protection program allows a computer to function as: a subroutine choosing means for accepting a processing request, and choosing a subroutine which executes the processing request; a memory-area specifying means for specifying a memory area which is used by the subroutine that is chosen by the subroutine choosing means; and a subroutine calling means for setting, to the writing permission, the writing attribute of the memory area which is specified by the memory-area specifying means, thereafter calling and executing the subroutine that is chosen by the subroutine choosing means, and setting, to the writing prohibition, the writing attribute of the memory area which is set to the writing permission after completing the execution of the subroutine.

According to this configuration, before a subroutine is execute, only the writing attribute of the memory area which is used by the subroutine is set to the writing permission. Then, the subroutine is called and executed. After the subroutine has been executed, the writing attribute of the memory area which has been set to the writing permission is set to the writing prohibition. Therefore, only while the subroutine is being executed, permission is given to write in the memory area which corresponds to the subroutine, and writing in the other memory areas is prohibited. This prevents a memory from being improperly rewritten by a malfunction in a subroutine.

According to the present invention, only while a subroutine is in execution, permission is given to write in the memory area which corresponds to the subroutine, and writing in the other memory areas is prohibited. This prevents a memory from being improperly rewritten by a malfunction in a subroutine. As a result, an operating system becomes securer. Besides, compared with the case where a virtual address space is allocated for each process, an overhead which is taken to change virtual address spaces is not produced. This prevents the whole system's performance from deteriorating.

These and other objects, features and advantages of the present invention will become more apparent upon reading of the following detailed description along with the accompanied drawings.

### BRIEF DESCRIPTION OF THE DRAWINGS

FIG. 1 is a block diagram, showing the configuration of a memory protection unit according to a first embodiment of the present invention.

FIG. 2 is a representation, showing an example of a subroutine management table.

FIG. 3 is a representation, showing an example of a memory-area management table.

FIG. 4 is a flow chart, showing a processing procedure of the memory protection unit according to the first embodiment of the present invention.

FIG. 5 is a representation, showing an example of a memory area and writing attribute information according to the first embodiment of the present invention.

FIG. 6 is a representation, showing an example of a subroutine management table according to the first embodiment of the present invention.

FIG. 7 is a representation, showing an example of a memory-area management table according to the first embodiment of the present invention.

FIG. 8 is a representation, showing an example of a memory area and writing attribute information in the case where the writing attribute information is set to a writing permission.

FIG. 9 is a block diagram, showing the configuration of a memory protection unit according to a second embodiment of the present invention.

FIG. 10 is a representation, showing an example of a series of processing which relates to an interruption in computer architecture.

FIG. 11 is a flow chart, showing a processing procedure at the time when an interruption takes place in the memory protection unit according to the second embodiment of the present invention.

FIG. 12 is a block diagram, showing the configuration of a memory protection unit according to a third embodiment of the present invention.

FIG. 13 is a flow chart, showing a processing procedure at the time when an interruption takes place in the memory protection unit according to the third embodiment of the present invention.

FIG. 14 is a block diagram, showing the configuration of a memory protection unit according to a fourth embodiment of the present invention.

FIG. 15 is a representation, showing an example of a module management table.

FIG. 16 is a flow chart, showing a processing procedure of the memory protection unit according to the fourth embodiment of the present invention.

FIG. 17 is a flow chart, showing an exceptional processing by the memory protection unit according to the fourth embodiment of the present invention.

### DETAILED DESCRIPTION OF INVENTION

Hereinafter, a memory protection unit, a memory protection method, and a computer-readable record medium in which a memory protection program is recorded, according to an embodiment of the present invention, will be described with reference to the drawings.

### First Embodiment

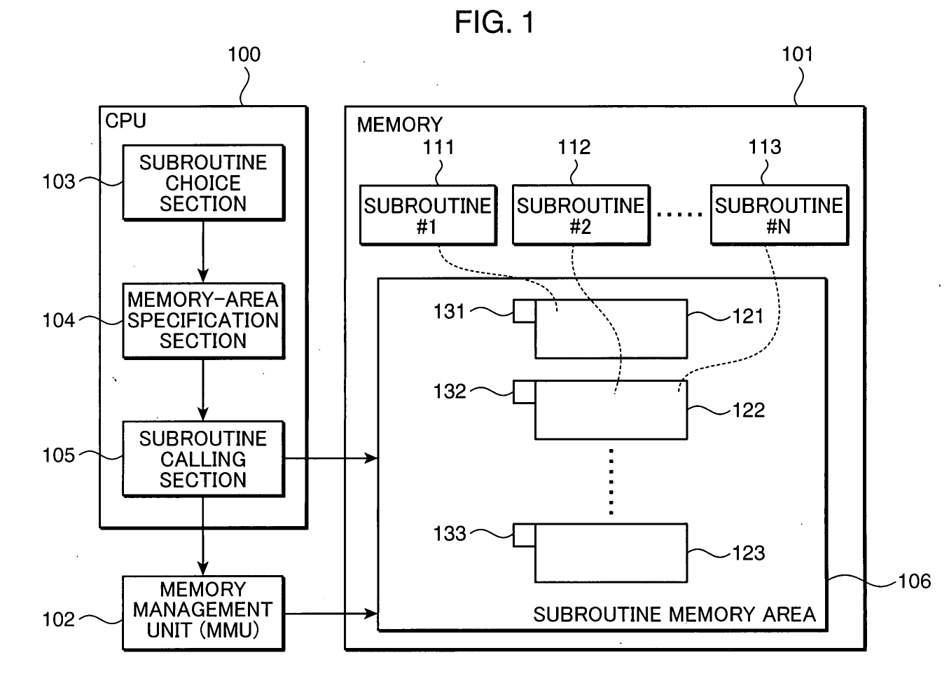

FIG. 1 is a block diagram, showing the configuration of a memory protection unit according to a first embodiment of the present invention. Herein, the Linux operating system is used as an example. For the present invention, operating systems except the Linux may also be used, such as UNIX (registered trademark), Windows (registered trademark) and TRON (registered trademark).

The memory protection unit shown in FIG. 1 is configured by: a CPU (or central processing unit) 100; a memory 101; and a memory management unit (or MMU) 102. The CPU 100, the memory 101 and the memory management unit 102 can mutually transmit and receive data, for example, through a bus.

In the memory 101, there are allocated areas which store a plurality of subroutines #1, #2, . . . #N (111, 112, 113), and a subroutine memory area 106 which is used by the subroutines. As the memory 101, an optional type can be used, for example, an RAM (or random access memory) or a flash memory. In addition, the memory 101 is not limited to a single memory. It may also be formed by combining different types of memories, including a plurality of the same type memories or ROMs (or read only memories). Besides, an external storage unit can also be used. Further, a memory area which is not used for subroutines may also be included in the memory 101.

The subroutines #1, #2, . . . #N (111, 112, 113) are a machine-language instruction string which is written in the memory. For example, a function in the Linux kernel, or the like, is equivalent to a subroutine.

Moreover, in the subroutine memory area 106, there are allocated a plurality of memory areas 121, 122, 123. For example, memory areas which are used by kernel modules of the Linux are equivalent to the memory areas 121, 122, 123. Each memory area is provided with writing attribute information (131, 132, 133). The writing attribute information is information which shows whether writing in each memory area 121, 122, 123 is permitted or prohibited. For example, in computer architecture which includes a paging mechanism, one memory area can be made up as a set of one or more memory pages. In this case, a page table descriptor which has the attribute information of each memory page is writing attribute information of a memory area. Herein, the present invention may also be realized, in addition to a paging mechanism, in computer architecture which includes a segment mechanism or the like.

The memory areas which is included in the subroutine memory area 106 correspond to the subroutines. The broken line which connects the subroutine 111 and the memory area 121, the broken line which connects the subroutine 112 and the memory area 122, the broken line which connects the subroutine 113 and the memory area 122, each show an example in which a subroutine corresponds to a memory area. This example shows that the memory area which is used by the subroutine 111 is the memory area 121, and the memory area which is used by the subroutine 112 and the subroutine 113 is the memory area 122. Herein, in this example, one memory area corresponds to each subroutine. However, the present invention is not limited to this. Several memory areas may also be allocated for one subroutine.

The memory management unit (or MMU) 102 manages writing in a memory area. When an instruction is issued to write in a memory area while a subroutine is being executed, the memory management unit 102 controls writing in the memory area which corresponds to the writing instruction. For example, when writing instruction is issued for a memory area where the writing attribute information is set to the writing permission, the writing is executed in the corresponding memory area, and when the instruction is executed to write in the memory area where the writing attribute information is set to the writing prohibition, a memory protection exception is issued. Herein, this memory protection exception will be described in detail in a fourth embodiment of the present invention.

The CPU 100 functions as a subroutine choice section 103, a memory-area specification section 104, and a subroutine calling section 105. Those functions are realized by executing a memory protection program which is recorded beforehand in a computer-readable record medium such as an ROM.

The subroutine choice section 103 chooses a subroutine which can properly respond to a system call or a processing request from within the Linux kernel. The subroutine choice section 103 holds, for example, a subroutine management table which relates a subroutine to every system call or processing request. Using this subroutine management table, it chooses a predetermined subroutine from among several subroutines. Then, the subroutine choice section 103 outputs, to the memory-area specification section 104, information of the subroutine it has chosen. Herein, the subroutine's information is expressed, for example, by an address within the subroutine's memory space, an identification (or ID) for identifying the subroutine, or the like.

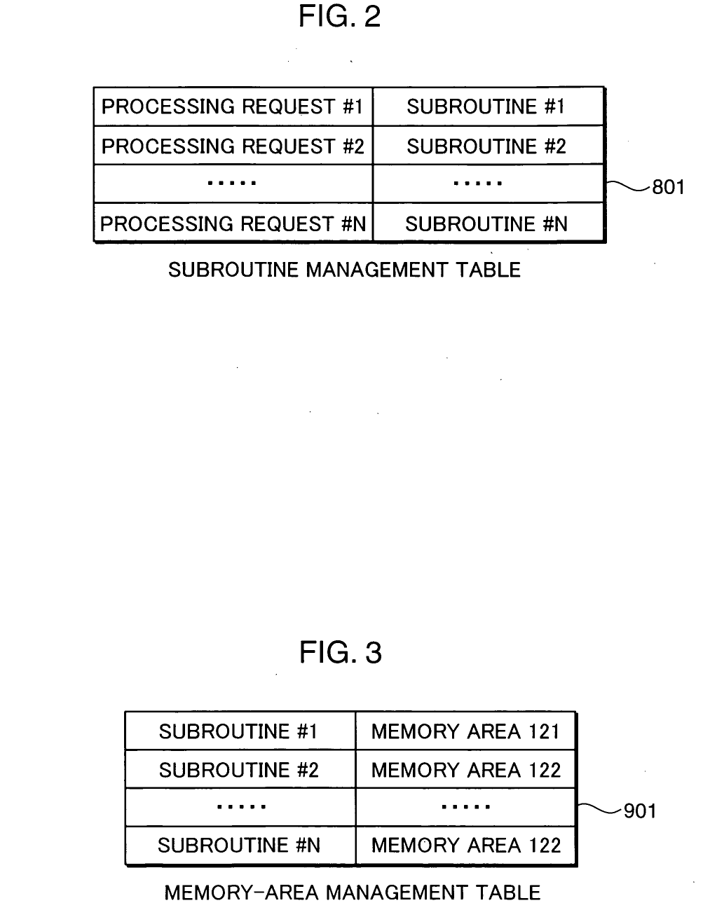

FIG. 2 is a representation, showing an example of a subroutine management table. A subroutine management table 801 in FIG. 2 shows an example in which the subroutine #1 corresponds to a processing request #1, the subroutine #2 corresponds to a processing request #2, and the subroutine #N corresponds to a processing request #N. In this example, when the subroutine choice section 103 receives the processing request #1, the subroutine choice section 103 chooses the corresponding subroutine #1, based on the subroutine management table 801. Herein, according to this embodiment, the subroutine choice section 103 holds the subroutine management table 801. However, it may also be stored in the memory 101. Besides, each subroutine may also hold information on a system call or a processing request which corresponds to the subroutine.

In the former FIG. 1, the memory-area specification section 104 accepts the subroutine information which has been chosen by the subroutine choice section 103. Then, it checks and specifies the memory area which corresponds to this subroutine. Then, the memory-area specification section 104 outputs, to the subroutine calling section 105, information of the memory area it has specified. For example, if the memory area which corresponds to the subroutine 111 is the memory area 121, the memory-area specification section 104 outputs the memory area 121's information when the subroutine 111's information is inputted. Herein, the memory area's information is expressed, for example, by an address within the memory area's memory space, an identification (or ID) for identifying the memory area, or the like.

The memory-area specification section 104 holds, for example, a memory-area management table which relates a memory area to every subroutine. It decides a memory area, using this memory-area management table. FIG. 3 is a representation, showing an example of a memory-area management table. In a memory-area management table 901 in FIG. 3, the memory area 121 corresponds to the subroutine #1, the memory area 122 corresponds to the subroutine #2, and the memory area 122 corresponds to the subroutine #N. Further, not shown subroutines #3 to #(N-1) are given with not shown ones of the memory areas 106 for subroutines, respectively. Herein, according to this embodiment, the memory-area specification section 104 holds the memory-area management table 901. However, it may also be stored in the memory 101. Besides, each subroutine may also hold information of the memory area which corresponds to the subroutine. In addition, in the memory-area management table 901, a plurality of memory areas may also which correspond to one subroutine.

Returning to FIG. 1, the subroutine calling section 105 accepts the subroutine information which has been outputted by the subroutine choice section 103, and the memory-area information which has been outputted by the memory-area specification section 104. Then, it sets, to the writing permission, writing attribute information of the memory area it has accepted. Next, it calls the subroutine it has accepted. Herein, in an initial state, writing attribute information of each memory area is all set to the writing prohibition. Then, the subroutine calling section 105 resets, to the writing prohibition, the memory area's writing attribute information which is set to the writing permission after completing the execution of the subroutine it has called. In addition, as described earlier, it notifies the memory management unit 102 of the instruction to write in the memory area while the subroutine is in execution. Then, the memory management unit 102 controls writing in the memory area.

Herein, not all subroutines have to be protected. Only subroutines which are preset as protected ones may also be protected. Besides, when software is updated by downloading it or the like, or in such another case, a subroutine whose memory is to be protected can be changed by newly registering and updating it.

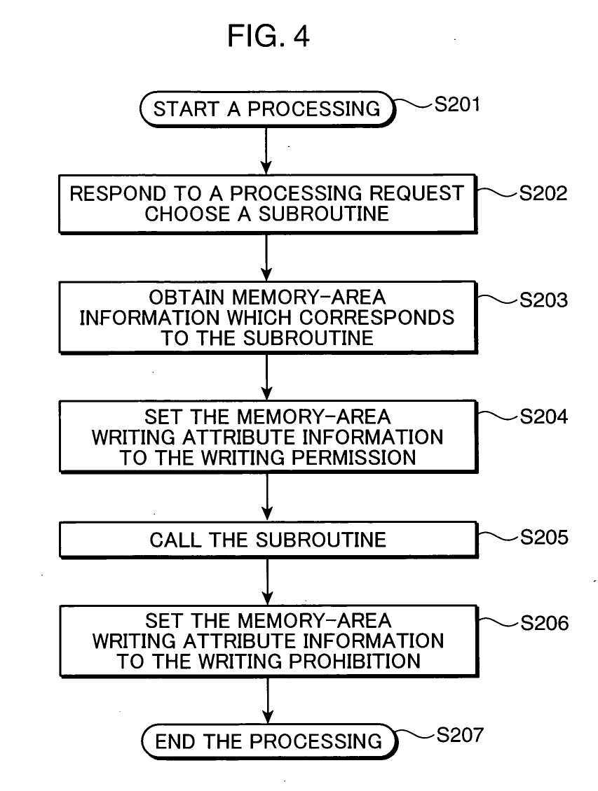

Next, description is given about an operation of the memory protection unit according to the first embodiment of the present invention. FIG. 4 is a flow chart, showing a processing procedure of the memory protection unit according to the first embodiment of the present invention. If a system call from a user program, or a processing request to call a predetermined subroutine such as a function call from within a kernel, is made, then the memory protection unit starts a memory protection processing (in a step S201).

The subroutine choice section 103 accepts the system call from a user program, or the processing request such as a function call from within a kernel. The subroutine choice section 103 chooses a subroutine which responds to the processing request, by referring to the subroutine management table 801. Then, the subroutine choice section 103 outputs, to the memory-area specification section 104, information of the subroutine it has chosen (in a step S202). Herein, the subroutine's information is expressed, for example, by an address within the subroutine's memory space, an ID for identifying the subroutine, or the like. Herein, for example, description is given in the case where the subroutine 111 is chosen.

Next, the memory-area specification section 104 accepts the subroutine information which has been outputted at the step S202. Then, it specifies the memory area which corresponds to this subroutine, by referring to the memory-area management table 901. Sequentially, the memory-area specification section 104 obtains information of the memory area it has specified. Then, it outputs, to the subroutine calling section 105, the memory-area information it has obtained (in a step S203). Herein, the memory area's information is expressed, for example, by an address within the memory area's memory space, an ID for identifying the memory area, or the like. For example, in the case where the subroutine information which has been outputted at the step S202 is the subroutine 111, and the memory area which corresponds to the subroutine is the memory area 121, the memory-area specification section 104 outputs information of the memory area 121.

Next, the subroutine calling section 105 accepts the subroutine information which has been outputted at the step S202, and the memory-area information which has been outputted at the step S203. Then, it rewrites, to the writing permission, writing attribute information of the memory area that is shown in the memory-area information which it has accepted (in a step S204). For example, in the case the memory-area information which has been outputted at the step S203 is the memory area 121, the subroutine calling section 105 rewrites, to the writing permission, the contents of the writing attribute information 131 which corresponds to the memory area 121. Herein, according to this embodiment, the subroutine information which shows which subroutine should be executed is sent to the subroutine calling section 105, via the memory-area specification section 104. However, the present invention is not limited especially to this. The subroutine information may also be sent to the subroutine calling section 105, from the subroutine choice section 103.

Next, the subroutine calling section 105 specifies a subroutine which it should execute, based on the subroutine information it has accepted. Then, it calls and executes the subroutine it has specified (in a step S205). For example, in the case the subroutine information which has been outputted at the step S202 is the subroutine 111, the subroutine calling section 105 calls the subroutine 111 from the memory 101 and executes it.

After finishing executing the subroutine it has called, the subroutine calling section 105 resets, to the writing prohibition, the memory-area writing attribute information which has been set to the writing permission at the step S204 (in a step S206). For example, in the case the memory-area information which has been outputted at the step S203 is the memory area 121, the subroutine calling section 105 sets, to the writing prohibition, the contents of the writing attribute information 131 which corresponds to the memory area 121.

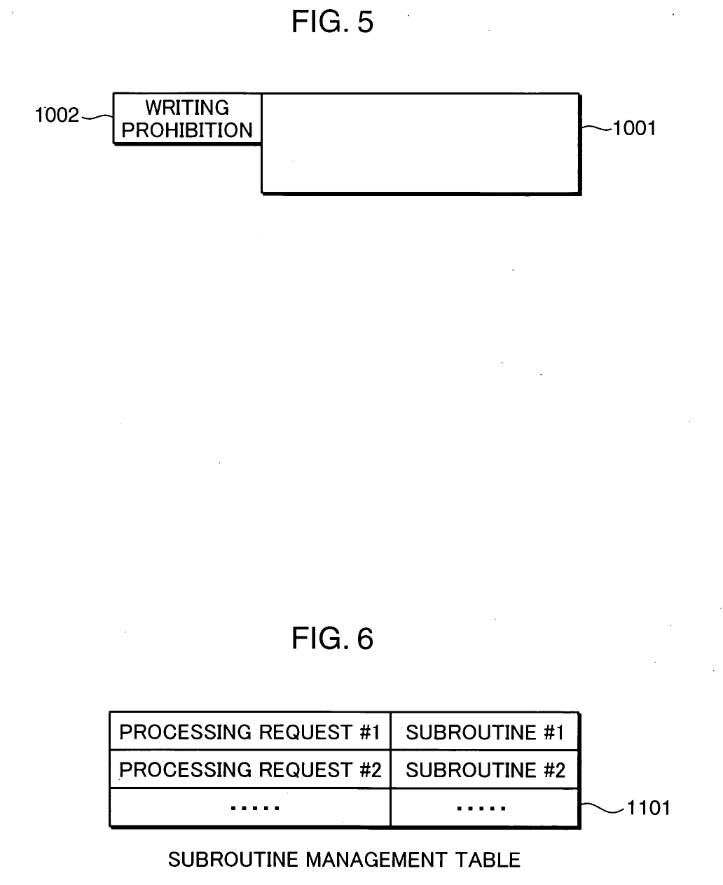

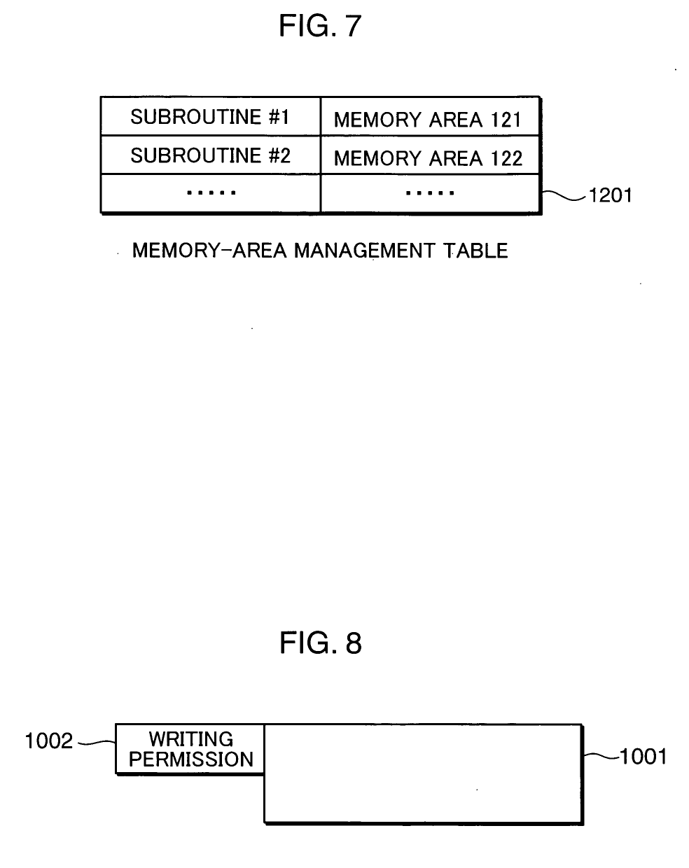

Next, description is given about an example of the case of a normal memory writing. Herein, a specific case is considered in which the processing starts from the state in FIG. 5, FIG. 6 and FIG. 7.

FIG. 5 is a representation, showing an example of a memory area and writing attribute information according to the first embodiment of the present invention. A memory area 1001 in FIG. 5 is the same as the memory area 121 or the like in FIG. 1. Writing attribute information 1002 is the same as the writing attribute information 131 or the like in FIG. 1. The writing attribute information 1002 is a writing attribute which shows whether writing in the memory area 1001 is permitted or prohibited. At this point of time, it is set to the writing prohibition. FIG. 6 is a representation, showing an example of the state of a subroutine management table. In a subroutine management table 1101 shown in FIG. 6, the subroutine which corresponds to a processing request #1 is set to the subroutine #1, and the subroutine which corresponds to a processing request #2 is set to the subroutine #2. FIG. 7 is a representation, showing an example of the state of the memory-area management table. In a memory-area management table 1201 shown in FIG. 7, the memory area which corresponds to the subroutine #1 is set to the memory area 121, and the memory area which corresponds to the subroutine #2 is set to the memory area 122.

Let's assume that in this state, the subroutine choice section 103 has accepted the processing request #1. In the step S202 of FIG. 4, the subroutine choice section 103 chooses the subroutine #1 which corresponds to the processing request #1, based on the subroutine management table 1101. Next, in the step S203 of FIG. 4, the memory-area specification section 104 specifies the memory area 121 as the memory area which corresponds to the subroutine #1, based on the memory-area management table 1201. The memory area 121 is an area which corresponds to the subroutine #1, and a memory area which is read and written by the subroutine #1. At this time, before the subroutine #1 is executed, in the step S204, the writing attribute information of the memory area 121 is set to be writable by the subroutine calling section 105. FIG. 8 shows a state at this time.

FIG. 8 is a representation, showing an example of the memory area and the writing attribute information in the case where the writing attribute information is set to the writing permission. It is different from FIG. 5, in terms of the fact that the writing attribute information 1002 is set to the writing permission, not the writing prohibition.

Thereafter, in the step S205, the subroutine calling section 105 calls the subroutine #1. If an instruction to write in the memory area 121 is executed while the subroutine #1 is in execution, a normal writing is executed. This is because a permission is given to write in the memory area 121. After the subroutine #1 has been executed, in the step S206, the subroutine calling section 105 sets, to the writing prohibition, the writing attribute information of the memory area 121. Consequently, the state of the memory area 1001 returns to that of FIG. 5. Therefore, when the subroutine #1 which corresponds to the memory area 121 is executed, writing in the memory area 121 is normally executed.

Next, description is given about an example of the case of an abnormal memory writing. In the same way as the above described normal case, a specific case is considered in which the processing starts from the state in FIG. 5, FIG. 6 and FIG. 7. At this time, while the subroutine #2 is executed, let's assume that the subroutine calling section 105 has tried to write in the memory area 121. The memory area 121 is the memory area which corresponds to the subroutine #1. Thus, a permission to write is given only when the subroutine #1 is executed. While the subroutine #2 which does not correspond to the memory area 121 is executed, writing is prohibited in the memory area 121. Therefore, an instruction to write in the memory area 121 is issued while the subroutine #2 is executed, the memory management unit 102 issues a memory-protection exception. Thereby, the writing is not executed. Accordingly, when the subroutine which does not correspond to the memory area 121 is executed, the writing is not executed in the memory area 121. This helps protect the memory area 121's data from its malfunction.

As described above, a subroutine cannot write in the memory area which does not correspond. This prevents a memory from being improperly rewritten by a malfunction. As a result, an operating system becomes securer. Besides, compared with the case where a virtual address space is allocated for each process, an overhead which is taken to change virtual address spaces is not produced since the process space need not to be switched. This prevents the whole system's performance from deteriorating.

### Second Embodiment

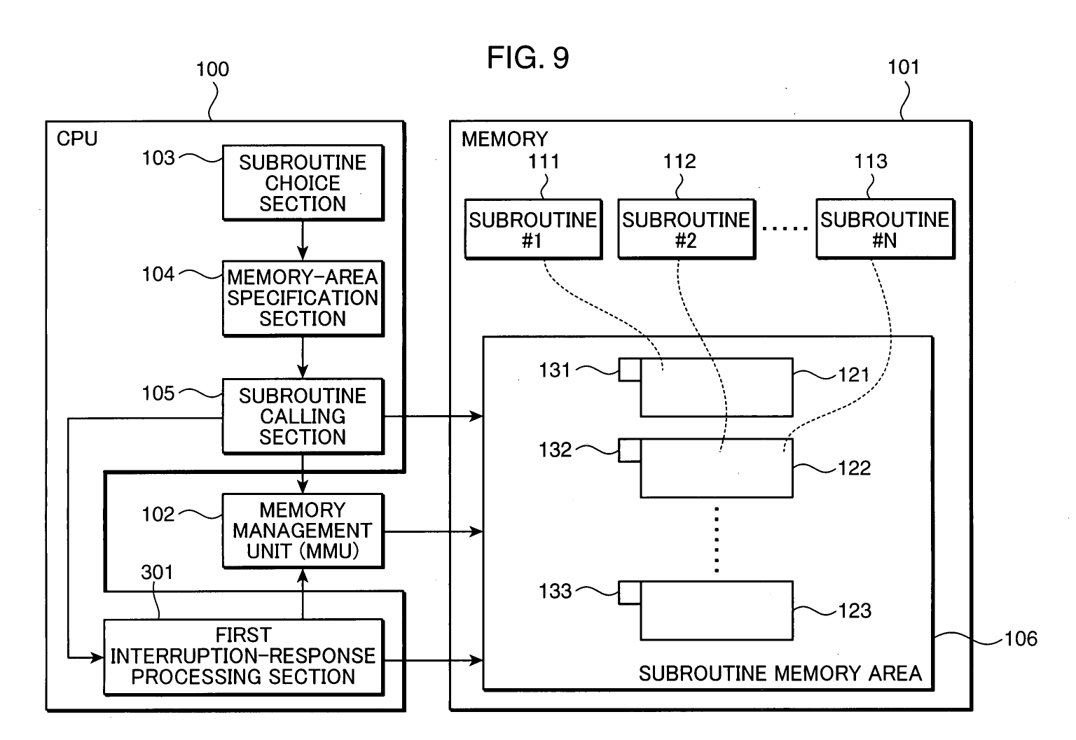

FIG. 9 is a block diagram, showing the configuration of a memory protection unit according to a second embodiment of the present invention. The memory protection unit shown in FIG. 9 is configured by: a CPU (or central processing unit) 100; a memory 101; and a memory management unit (or MMU) 102. The CPU 100, the memory 101 and the memory management unit 102 can mutually transmit and receive data, for example, through a bus. The CPU 100 functions as a subroutine choice section 103, a memory-area specification section 104, a subroutine calling section 105, and a first interruption-response processing section 301. Those functions are realized by executing a memory protection program which is recorded beforehand in a computer-readable record medium such as an ROM. In FIG. 9, the components which have the same configuration as those in FIG. 1 are given the identical reference numerals and characters. Thus, their description is omitted. In FIG. 9, the part which is different from FIG. 1 is the first interruption-response processing section 301.

When an interruption is issued, the first interruption-response processing section 301 obtains the writing attribute information of the memory area which has been set to the writing permission by the subroutine calling section 105. Then, it set, to the writing prohibition, the memory-area writing attribute information it has obtained. Thus, it executes the processing which responds to the interruption. After completing the execution of the interruption response processing, the first interruption-response processing section 301 obtains the memory-area writing attribute information which has been set to the writing prohibition. Then, it resets, to the writing permission, the memory-area writing attribute information it has obtained.

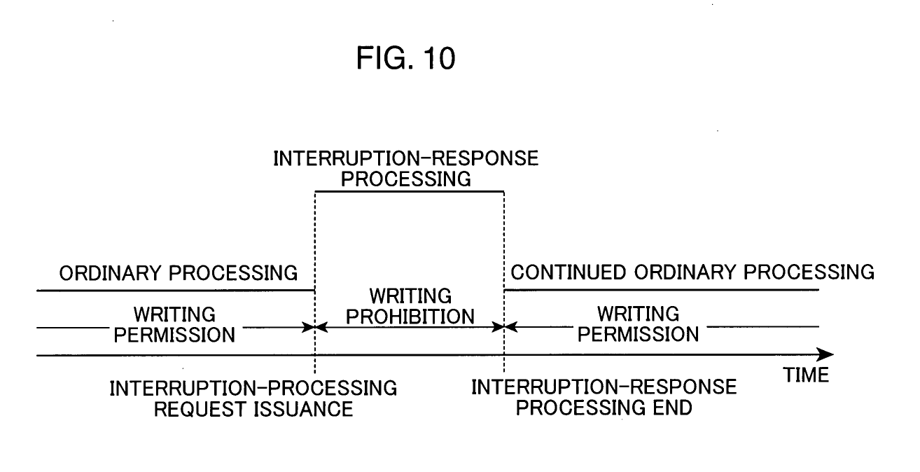

In a general computer architecture, when an interruption is issued, a predetermined interruption-response processing starts. Then, a proper response processing is executed, and thereafter, a return is made to the processing which was in execution before the interruption. If an interruption is prohibited, the processing which responds to the interruption is executed when the interruption prohibition is lifted. FIG. 10 is a representation, showing an example of a series of processing which relates to an interruption in a general computer architecture. First, an ordinary processing is in execution. When an interruption processing request is made in proper timing, an interruption-response processing is executed. After interruption-response processing is completed, a return is made to the ordinary processing, and the processing continues. According to the second embodiment of the present invention, when an interruption processing request is made, the writing attribute information of the memory area which has been set to the writing permission for the ordinary processing is set to the writing prohibition. Thereafter, the interruption-response processing is executed. After the interruption-response processing has been executed, the writing attribute information of the memory area for the ordinary processing is set again to the writing permission.

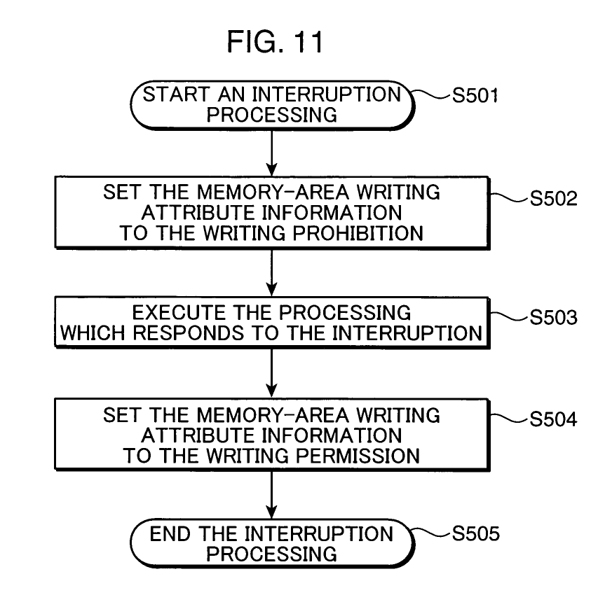

FIG. 11 is a flow chart, showing a processing procedure at the time when an interruption takes place according to the second embodiment of the present invention. First, if an interruption processing request is made, the first interruption-response processing section 301 starts an interruption response processing (in a step S501).

The first interruption-response processing section 301 accepts the interruption processing request. Then, the first interruption-response processing section 301 obtains the writing attribute information of the memory area which has been set to the writing permission by the subroutine calling section 105. Then, it set, to the writing prohibition, the memory-area writing attribute information (in a step S502).

Next, the first interruption-response processing section 301 calls and executes the processing which responds to the interruption it has obtained. For example, in the case of the Linux, a registered interruption handler function is called and executed (in a step S503).

After it has finished executing the processing which responds to the interruption, the first interruption-response processing section 301 resets, to the writing permission, the memory-area writing attribute information which has been set to the writing prohibition at the step S502 (in a step S504). Herein, in the first interruption-response processing section 301, there is stored an address of the memory area which has been set to the writing prohibition. After it has finished executing the interruption response processing, it reads the address. Then, it sets, to the writing permission, the writing attribute information which corresponds to the memory area of the address it has read.

After the interruption response processing is completed, a return is made to the processing in execution before the interruption was issued. Then, it is executed, and the interruption processing ends (in a step S505).

According to the second embodiment, when an interruption takes place while a subroutine is executed in the step S205 of FIG. 4, an interruption response processing is not executed before the memory area where writing is permitted for the subroutine in execution is set to the writing prohibition. Therefore, the memory area whose writing permission was given for the subroutine that was in execution before the interruption can be prevented from being improperly rewritten by a malfunction which may occur during the interruption response processing.

### Third Embodiment

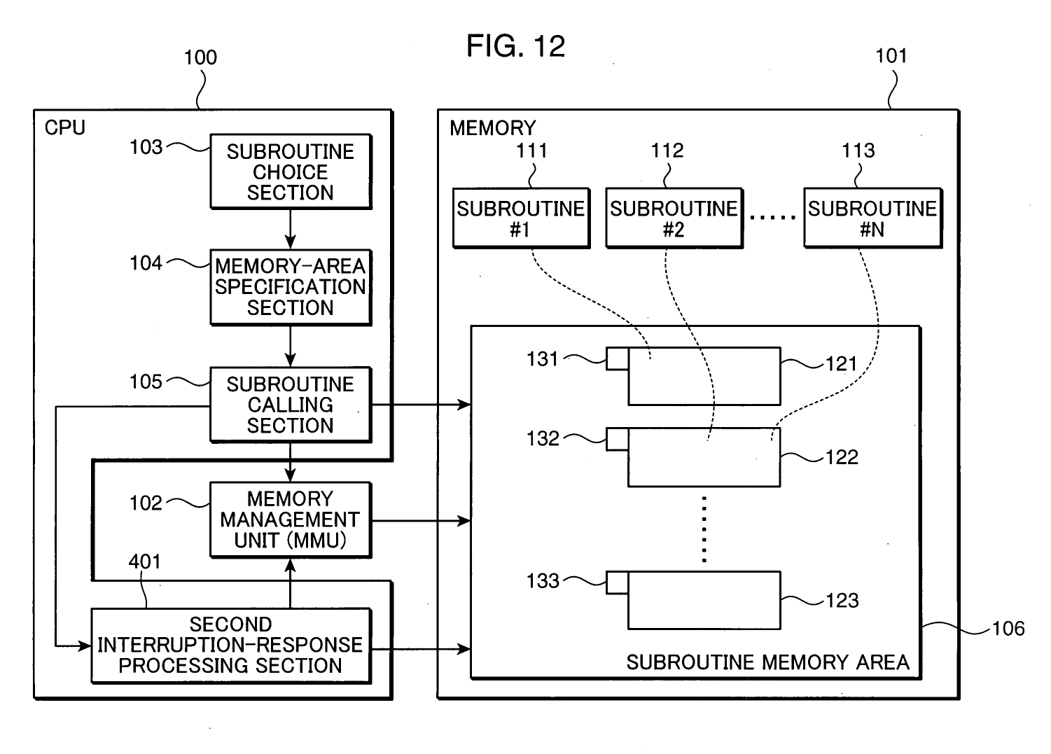

FIG. 12 is a block diagram, showing the configuration of a memory protection unit according to a third embodiment of the present invention. The memory protection unit shown in FIG. 12 is configured by: a CPU (or central processing unit) 100; a memory 101; and a memory management unit (or MMU) 102. The CPU 100, the memory 101 and the memory management unit 102 can mutually transmit and receive data, for example, through a bus. The CPU 100, the memory 101 and the memory management unit 102 can mutually transmit and receive data, for example, through a bus. The CPU 100 functions as a subroutine choice section 103, a memory-area specification section 104, a subroutine calling section 105, and a second interruption-response processing section 401. Those functions are realized by executing a memory protection program which is recorded beforehand in a computer-readable record medium such as an ROM. In FIG. 12, the components which have the same configuration as those in FIG. 9 are given the identical reference numerals and characters. Thus, their description is omitted. In FIG. 12, the part which is different from FIG. 9 is the second interruption-response processing section 401.

Herein, that processing is divided in two, or the first half (i.e., top half) and the second half (i.e., bottom half). When an interruption is issued, the second interruption-response processing section 401 obtains the memory area which has been set to the writing permission by the subroutine calling section 105. Then, it executes the first half of the processing which responds to the interruption. Herein, that processing is divided in two, or the first half and the second half. After completing the first half of the processing which responds to the interruption, it sets, to the writing prohibition, the memory-area writing attribute information it has obtained. Then, the second interruption-response processing section 401 executes the second half of the processing which responds to the interruption. After completing the second half of the processing which responds to the interruption, it resets, to the writing permission, the memory-area writing attribute information it has obtained. Herein, the first half of the interruption response processing is the processing which accepts the interruption response processing. On the other hand, the second half is the processing which executes the interruption response processing. For example, in the case of the Linux, the first half is the top-half processing and the second half is the bottom-half processing.

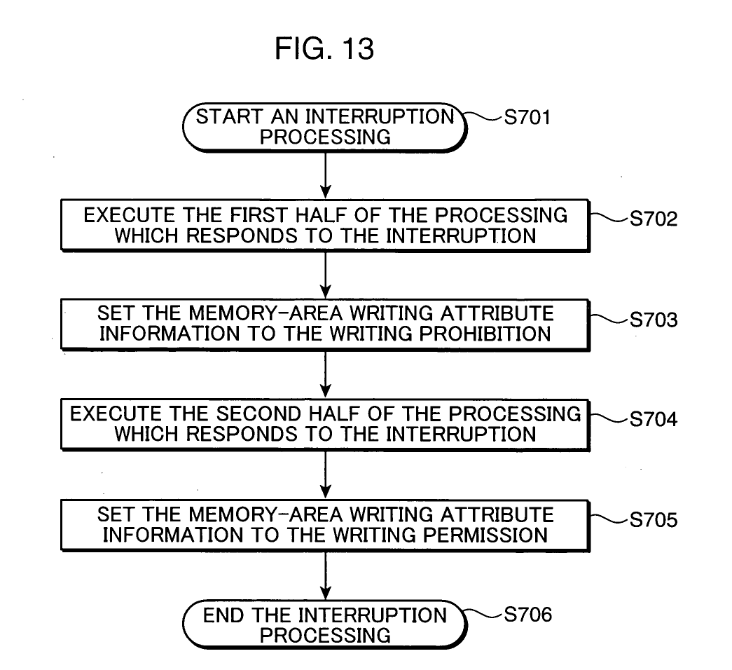

FIG. 13 is a flow chart, showing a processing procedure at the time when an interruption takes place according to the third embodiment of the present invention. First, if an interruption processing request is made, the second interruption-response processing section 401 starts an interruption response processing (in a step S701). Herein, the processing which responds to the interruption is divided in advance in two, or the first half and the second half.

The second interruption-response processing section 401 accepts the interruption processing request. Then, the second interruption-response processing section 401 calls and executes the first half of the processing which responds to the interruption (in a step S702). At this time, the memory-area writing attribute information which is used by the subroutine in execution remains set to the writing permission.

After it has finished executing the processing it has called (the first half of the processing which responds to the interruption), the second interruption-response processing section 401 obtains the memory area which has been set to the writing permission by the subroutine calling section 105. Then, it sets the memory-area writing attribute information to the writing prohibition (in a step S703).

Next, the second interruption-response processing section 401 calls and executes the second half of the processing which responds to the interruption (in a step S704).

After it has finished executing the processing it has called (the second half of the processing which responds to the interruption), the second interruption-response processing section 401 resets, to the writing permission, the memory-area writing attribute information which has been set to the writing prohibition at the step S703 (in a step S705). Herein, in the second interruption-response processing section 401, there is stored an address of the memory area which has been set to the writing prohibition. After it has finished executing the second half of the interruption response processing, it reads the address. Then, it sets, to the writing permission, the writing attribute information which corresponds to the memory area of the address it has read.

After the interruption response processing is completed, a return is made to the processing in execution before the interruption was issued. Then, it is executed, and the interruption processing ends (in a step S706).

According to the third embodiment, when an interruption takes place while a subroutine is executed in the step S205 of FIG. 4, first, the first half of the processing which responds to the interruption is executed. Thereafter, the memory area where writing is permitted for the subroutine in execution is set to the writing prohibition. Then, the second half of the interruption response processing is called.

In terms of the control of embedded equipment, a quick response is usually needed to an interruption. Hence, the first half and the second half can be embodied like this. An important processing which should swiftly respond to an interruption is set as the first half of the interruption response processing. On the other hand, a processing which may be delayed to some extent is set as the second half of the interruption response processing. According to the third embodiment, the first half of the processing which responds to the interruption is promptly executed. In addition, even if a malfunction occurs in the second half of the processing which responds to the interruption, the memory area whose writing permission was given for the subroutine that was in execution before the interruption can be kept from being improperly rewritten.

While the first half of the processing which responds to the interruption is executed, the memory area whose writing permission was given for the subroutine that was in execution before the interruption remains at the writing permission. Thus, improper rewriting can occur. However, the processing which responds quickly to the interruption is usually simple. For example, restarting of a processing having waited for an interruption. There is little possibility that a malfunction occurs. Therefore, the first half of the processing which responds to the interruption is swiftly executed, so that both security and the execution performance by an interruption response speed can be well balanced.

Herein, the processing which responds to the interruption is divided in two, the first half and the second half. However, it may also be divided into an arbitrary number of parts.

### Fourth Embodiment

Next, a fourth embodiment of the present invention will be described.

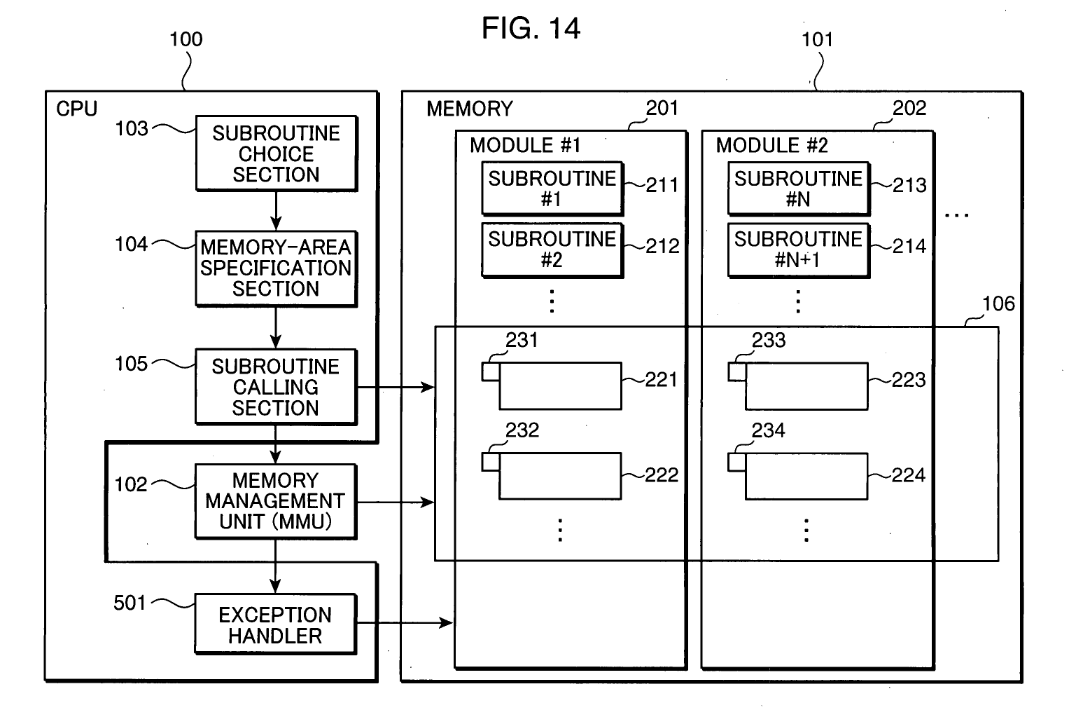

FIG. 14 is a block diagram, showing the configuration of a memory protection unit according to the fourth embodiment of the present invention. The memory protection unit shown in FIG. 14 is configured by: a CPU (or central processing unit) 100; a memory 101; and a memory management unit (or MMU) 102. The CPU 100, the memory 101 and the memory management unit 102 can mutually transmit and receive data, for example, through a bus. The CPU 100, the memory 101 and the memory management unit 102 can mutually transmit and receive data, for example, through a bus. The CPU 100 functions as a subroutine choice section 103, a memory-area specification section 104, a subroutine calling section 105, and an exception handler 501. Those functions are realized by executing a memory protection program which is recorded beforehand in a computer-readable record medium such as an ROM. In FIG. 14, the components which have the same configuration as those in FIG. 1 are given the identical reference numerals and characters. Thus, their description is omitted. In FIG. 14, the part which is different from FIG. 1 is the exception handler 501 and modules 201, 202.

In the memory 101, there are stored a plurality of modules 201, 202, . . . . A module is made up of at least one subroutine and at least one subroutine memory area. For example, the module 201 is made up of subroutines #1, #2, . . . (211, 212, . . . ), and memory areas 221, 222, . . . . The module 202 is made up of subroutines #N, #N+1, (213, 214, . . . ), and memory areas 223, 224, . . . .

When a memory protection exception is issued by the memory management unit 102, the exception handler 501 executes an exceptional processing which initializes the module which includes the subroutine where the memory protection exception has been issued. If the memory protection exception is issued, the memory management unit 102 outputs an exceptional processing request to the exception handler 501. This exceptional processing request includes information which specifies the subroutine where the memory protection exception has been issued. The exception handler 501 holds a module management table which relates a subroutine to a module. Using this module management table, it specifies the module which corresponds to the subroutine where the memory protection exception has been issued. Herein, as the exceptional processing, in addition to the processing which initializes a module, the processing which restores a module, or the like, may also be used. In other words, the exceptional processing may be a special processing which is executed in the following case. If a phenomenon takes place where an ordinary processing procedure cannot be continued while a subroutine is in execution, the processing procedure in execution is suspended at that time. Then, the above described special processing is executed according to such a phenomenon. Herein, the exception handler 501 is equivalent to an example of the exceptional processing means.

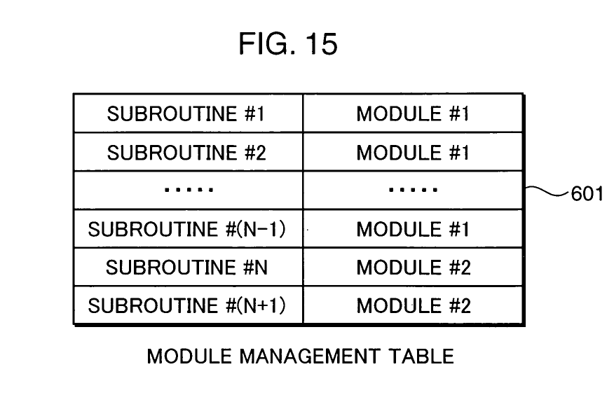

FIG. 15 is a representation, showing an example of the module management table. A module management table 601 of FIG. 15 shows an example where the module #1 corresponds to the subroutine #1, themodule#1 corresponds to the subroutine #2, and the module #2 corresponds to the subroutine #N. In the case of this example, when the exception handler 501 has received an exceptional processing request, the exception handler 501 specifies the module which corresponds to the subroutine where the memory protection exception has been issued, by referring to the module management table 601. Herein, according to this embodiment, the exception handler 501 holds the module management table 601. However, it may also be stored in the memory 101. Besides, each subroutine may also hold information on the module (i.e., information on which module a subroutine belongs to) which corresponds to the subroutine.

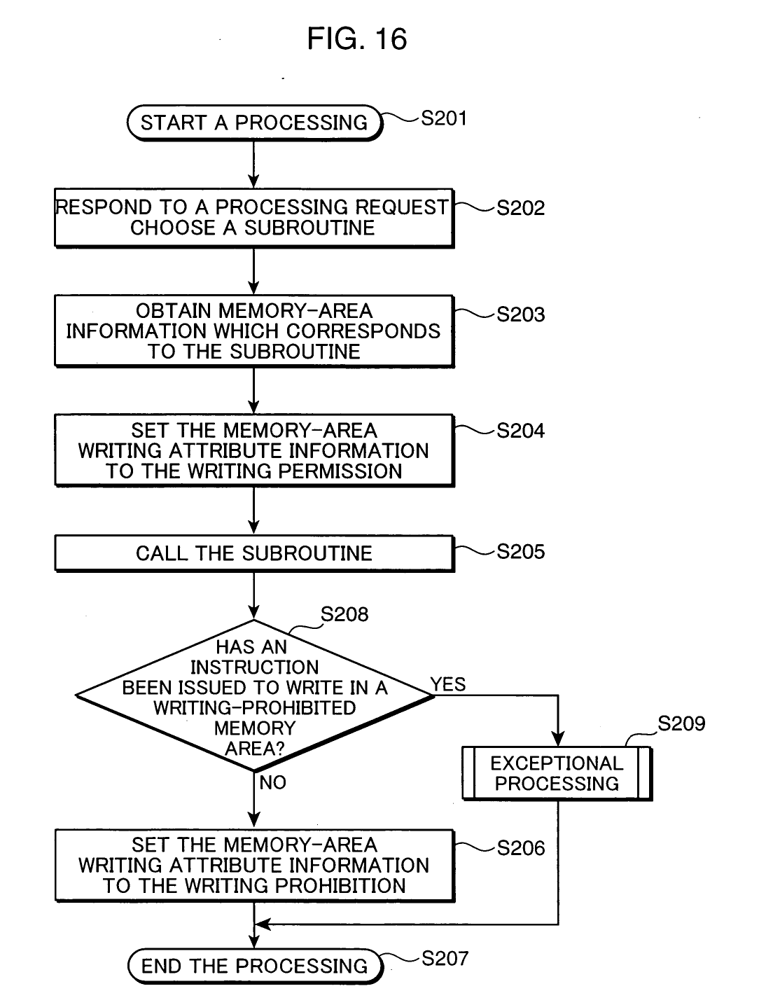

Next, description is given about an operation of the memory protection unit according to the fourth embodiment of the present invention. FIG. 16 is a flow chart, showing a processing procedure of the memory protection unit according to the fourth embodiment of the present invention. In FIG. 16, the steps which have the same processing as that of the first embodiment shown in FIG. 4 are given the identical reference numerals and characters. Thus, their description is omitted.

In a step S208, while a subroutine is being executed, the memory management unit 102 decides whether or not an instruction is issued to write in the memory area where the writing attribute information is set to the writing prohibition. Herein, if an instruction has not been issued to write in the memory area where the writing attribute information is set to the writing prohibition (YES at the step S208), the subroutine is kept executed. Then, the processing shifts to the step S206. On the other hand, if an instruction has been issued to write in the memory area where the writing attribute information is set to the writing prohibition (NO at the step S208), the processing shifts to a step S209. In other words, if an instruction has been executed to write in the memory area where the writing attribute information is set to the writing prohibition while a subroutine is being executed by the subroutine calling section 105, the memory management unit 102 issues a memory protection exception. Then, it outputs an exceptional processing request to the exception handler 501.

Next, in the step S209, the exception handler 501 executes the exceptional processing. Then, after the exceptional processing has been executed, the processing shifts to the step S207.

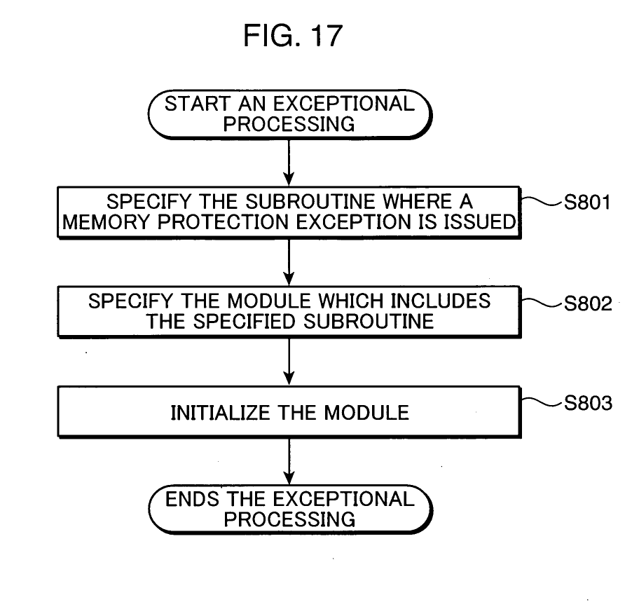

Herein, the exceptional processing in the step S209 of FIG. 16 will be described. FIG. 17 is a flow chart, showing the exceptional processing by the memory protection unit according to the fourth embodiment of the present invention.

First, the exception handler 501 specifies the subroutine where a memory protection exception has taken place (in a step S801). The memory management unit 102 is aware of the subroutine which is now in execution. Thus, the memory management unit 102 outputs, to the exception handler 501, execution subroutine information which shows which the subroutine is being executed at present. Herein, for example, the execution subroutine information is expressed by an identification (or ID) for identifying the subroutine, or the like. The exception handler 501 specifies the subroutine which is being executed at present, based on the inputted execution subroutine information.

Next, the exception handler 501 specifies the module which includes the subroutine which has been specified in the step S801 (in a step S802). Then, the exception handler 501 specifies the module which corresponds to the subroutine which has been specified in the step S801, by referring to the module management table. Herein, information on the specified module is expressed, for example, by an address within amodule's memory space, an ID for identifying a module, or the like.

Next, the exception handler 501 initializes the module which has been specified in the step S802 (in a step S803). Then, the exceptional processing is completed.

Herein, in FIG. 14, the exceptional processing will be specifically described in the case where only the writing attribute information 232 of the memory area 222 which is used by the subroutine #2 is set to the writing permission (i.e., the writing attribute information of the other memory areas is set to the writing prohibition).

Assuming that while the subroutine #2 is being executed, an instruction has been given to write in the memory area 223 of another module #2 by the memory management unit 102. At this time, the writing attribute information 233 of the memory area 223 is set to the writing prohibition. Thus, the memory management unit 102 cannot write in the memory area 223. As a result, a memory protection exception is issued. If the memory protection exception has been issued, the memory management unit 102 outputs an exceptional processing request to the exception handler 501. This exceptional processing request includes information which specifies the subroutine where the memory protection exception has been issued. Hence, the memory management unit 102 notifies the exception handler 501 that the memory protection exception has been issued while the subroutine #2 is being executed.

When the exceptional processing request is inputted, the exception handler 501 specifies the subroutine where the memory protection exception has been issued. Herein, the subroutine where the memory protection exception has been issued is specified as the subroutine #2. Then, the exception handler 501 specifies the module which corresponds to the subroutine #2, by referring to the module management table. In the module management table 601 shown in FIG. 15, the module #1 corresponds to the subroutine #2. Thereby, the exception handler 501 specifies the module which corresponds to the subroutine #2, as the module #1. Next, the exception handler 501 initializes the module #1 it has specified. The exception handler 501 executes the initialization in a module unit. After the module has been initialized, a system call from a user program, or a processing request such as a function call from within a kernel, is made again. Thus, the processing starts.

As described above, if an instruction has been given to write in the memory area where writing is prohibited while the subroutine is being executed, the exceptional processing is executed which initializes the module which includes the subroutine. This prevents the processing from stopping midway.

Herein, the present invention may also be realized by combining some of the above described first to fourth embodiments. For example, the memory protection unit according to the first embodiment shown in FIG. 1 may also be provided with at least one of the first interruption-response processing section 301 according to the second embodiment, the second interruption-response processing section 401 according to the third embodiment and the exception handler 501 according to the fourth embodiment.

The memory protection unit, the memory protection method and the computer-readable record medium in which the memory protection program is recorded, according to the present invention, are capable of preventing improper memory rewriting in a program which operates within one memory address space. They are useful for an operating system, such as embedded equipment which requires security, or the like. In addition, the memory protection unit, the memory protection method and the computer-readable record medium in which the memory protection program is recorded, according to the present invention, can be used for not only a computer, but also various types of home electrical appliances, data processing equipment, a mobile phone, industrial equipment, or the like.

This application is based on Japanese patent application serial No. 2003-426800, filed in Japan Patent Office on Dec. 24, 2003, the contents of which are hereby incorporated by reference.

Although the present invention has been fully described by way of example with reference to the accompanied drawings, it is to be understood that various changes and modifications will be apparent to those skilled in the art. Therefore, unless otherwise such changes and modifications depart from the scope of the present invention hereinafter defined, they should be construed as being included therein.

1. A memory protection unit, comprising:
a memory which includes at least one memory area that is used by at least one subroutine, and in which a writing attribute is set for every memory area, the writing attribute representing a writing permission or a writing prohibition;
a subroutine choosing means for accepting a processing request, and choosing a subroutine which executes the processing request;
a memory-area specifying means for specifying a memory area which is used by the subroutine that is chosen by the subroutine choosing means; and
a subroutine calling means for setting, to the writing permission, the writing attribute of the memory area which is specified by the memory-area specifying means, thereafter calling and executing the subroutine that is chosen by the subroutine choosing means, and setting, to the writing prohibition, the writing attribute of the memory area which is set to the writing permission after completing the execution of the subroutine.

2. The memory protection unit according to claim 1, wherein:
in the memory, a subroutine management table is stored which relates the processing request to a subroutine that corresponds to the processing request; and
the subroutine choosing means accepts a processing request, and chooses the subroutine that corresponds to the processing request, by referring to the subroutine management table.

3. The memory protection unit according to claim 1, wherein:
in the memory, a memory-area management table is stored which relates the subroutine to a memory area that is used by the subroutine; and
the memory-area specifying means specifies the memory area which is used by the subroutine that is chosen by the subroutine choosing means, by referring to the memory-area management table.

4. The memory protection unit according to claim 1, further comprising an interruption response processing means for: when an interruption processing request is issued while a subroutine is executed by the subroutine calling means, setting the writing attribute of the memory area which is used by the subroutine in execution, from the writing permission to the writing prohibition; thereafter calling and executing an interruption response processing which responds to the interruption processing request; and resetting, to the writing permission, the writing attribute of the memory area which is set to the writing prohibition after completing the execution of the interruption response processing.

5. The memory protection unit according to claim 1, further comprising an interruption response processing means for: when an interruption processing request is issued while a subroutine is executed by the subroutine calling means, calling and executing an interruption response processing which responds to the interruption processing request; in arbitrary timing when the interruption response processing is in execution, setting the writing attribute of the memory area which is used by the subroutine in execution, from the writing permission to the writing prohibition; and resetting, to the writing permission, the writing attribute of the memory area which is set to the writing prohibition after completing the execution of the interruption response processing.

6. The memory protection unit according to claim 5, wherein
the interruption response processing is divided in advance into a top half and a bottom half, and
the interruption response processing means: when an interruption processing request is issued while a subroutine is executed by the subroutine calling means, calls and executes the top half of an interruption response processing which responds to the interruption processing request; sets the writing attribute of the memory area which is used by the subroutine in execution, from the writing permission to the writing prohibition after completing the execution of the top half; calls and executes the bottom half of the interruption response processing after setting the writing attribute to the writing prohibition; and resets, to the writing permission, the writing attribute of the memory area which is set to the writing prohibition after completing the execution of the bottom half.

7. The memory protection unit according to claim 1, further comprising a memory-protection exception issuing means for issuing a memory-protection exception which is used to execute an exceptional processing when an instruction is issued to write in the memory area where the writing attribute is set to the writing prohibition.

8. The memory protection unit according to claim 7, wherein:
the memory includes a plurality of modules, each of the modules having at least one subroutine, and at least one memory area which is used by the subroutine; and
the memory-protection exception issuing means includes an exceptional processing means for executing an exceptional processing which specifies a subroutine in which an instruction is issued to write in the memory area where the writing attribute is set to the writing prohibition, specifies a module which includes the subroutine, and initializes the module.

9. The memory protection unit according to claim 8, wherein:
in the memory, a module management table is stored which relates the subroutine to a module that includes the subroutine; and
the exceptional processing means specifies the module that includes the subroutine, by referring to the module management table.

10. A memory protection method for managing writing in a memory including at least one memory area that is used by at least one subroutine by allowing the memory area to be settable with a writing attribute representing a writing permission or a writing prohibition, comprising:
a subroutine choosing step for accepting a processing request, and choosing a subroutine which executes the processing request;
a memory-area specifying step for specifying a memory area which is used by the subroutine that is chosen in the subroutine choosing step; and
a subroutine calling step for setting, to the writing permission, the writing attribute of the memory area which is specified in the memory-area specifying step, thereafter calling and executing the subroutine that is chosen in the subroutine choosing step, and setting, to the writing prohibition, the writing attribute of the memory area which is set to the writing permission after completing the execution of the subroutine.

11. A computer-readable record medium recorded with a memory protection program for managing writing in a memory including at least one memory area that is used by at least one subroutine by allowing the memory area to be settable with a writing attribute representing a writing permission or a writing prohibition; the memory protection program allowing a computer to function as:
a subroutine choosing means for accepting a processing request, and choosing a subroutine which executes the processing request;
a memory-area specifying means for specifying a memory area which is used by the subroutine that is chosen by the subroutine choosing means; and
a subroutine calling means for setting, to the writing permission, the writing attribute of the memory area which is specified by the memory-area specifying means, thereafter calling and executing the subroutine that is chosen by the subroutine choosing means, and setting, to the writing prohibition, the writing attribute of the memory area which is set to the writing permission after completing the execution of the subroutine.
